(19) United States
(12) Patent Application Publication
(10) Pub. No.: US 2018/0279656 A1
(43) Pub. Date: Oct. 4, 2018

(54) METHOD OF PRODUCING RETORT-STERILIZED COOKED RICE AND RETORT-STERILIZED CONTAINER-PACKED COOKED RICE

(71) Applicant: TOYO SEIKAN CO., LTD., Tokyo (JP)

(72) Inventors: Hidehito TAKAHASHI, Hyogo (JP); Yumiko INADA, Hyogo (JP)

(21) Appl. No.: 15/562,375

(22) PCT Filed: Mar. 3, 2016
(86) PCT No.: PCT/JP2016/056576

§ 371 Date: Sep. 27, 2017

(30) Foreign Application Priority Data
Mar. 30, 2015 (JP) 2015-069722

(51) Int. Cl. A23L 3/02; A23L 7/10; A23L 7/196

(52) U.S. Cl. CPC A23L 3/022; A23V 2002/00; A23L 7/1965; A23L 7/1975

(57) ABSTRACT

A method of producing retort-sterilized cooked rice including: a heating water-absorption step A for heating uncooked rice having a hardness ratio lower than 1 (one) for causing water to be absorbed therein such that resultant water-absorbed rice grains weigh from 2.0 to 2.6 times as much as the uncooked rice grains; a filling step B for filling the heated, water-absorbed rice grains in a packing container; a sealing step D for sealing the filled packing container; and a retort-sterilization step E for sterilizing the sealed packing container by heating and pressurizing. Also, retort-sterilized container-packed cooked rice comprises rice prepared by retort-sterilizing Indica rice with charging of inert gas in a headspace of the packing container such that the concentration of oxygen gas therein may range 1% or more and less than 2%.

### TECHNICAL FIELD

The present invention relates to a method of producing retort-sterilized cooked rice in which long grain rice is filled and sealed in a packing container and then subject to a retort sterilization by heating and pressurizing. The invention relates also to a retort-sterilized container-packed cooked rice.

### RELATED ART

In general, a food product having a pH value exceeding 4.6 and a water activity value exceeding 0.94 is classified as a “low acidity food product”, discriminated from an “acidic food product” which has a pH value of 4.6 or lower. For room-temperature commercial distribution of packed food products, FDA provides that commercial sterilization of the product be ensured. In Japan, Food Sanitation Act is applied to imposes a requirement that a low acidity food product be sterilized by either a method of heating the product at 120° C. for four minutes, with using Clostridium botulinum as the indicator bacteria or a sterilizing method (so-called “retort sterilization”) as effective as or more effective than the former method.

Cooked rice is normally classified as a low acidity food product. As such, for room-temperature commercial distribution of cooked rice in the form of a container-packed food product comprised of cooked rice packed in a container, it has been needed to effect its retort sterilization.

In the retort sterilization, for a retort-pouched food product formed by packing a subject object such as a food product in a bag-like packing container and sealing the container and then heating and pressurizing this container. For instance, hot water or steam processing is effected at a temperature ranging from 110 to 130° C. for a period of several minutes or several tens of minutes. Here, it is necessary to select such sterilization conditions that allow sufficient sterilization of the retort-pouched food product. On the other hand, it is essential to select such conditions that will not cause quality deterioration of the subject object after the sterilization process.

Patent Document 1 discloses a method in which uncooked rice (Japonica rice) and water are filled in a container and sealed therein and then cooking and retort sterilization are effected at one time. This method comprises an in-container rice cooking method. In this method, it is said that non-colored good-flavored cooked rice can be obtained by adjusting an amount of oxygen gas inside the container to be 4-12 mL per 100 g of uncooked rice at the room temperature with using inert gas.

### PRIOR-ART DOCUMENT

### Patent Document

Patent Document: Japanese Published Patent Hei. 8-24538

### SUMMARY

### Problem to be Solved by Invention

Indica rice is a long grain species of rice and accounts for 80% or more of the rice production amount in the world. The main production areas of Indica rice lie in Indochina peninsula and Southeast Asia such as Thailand. These areas are now undergoing high economic development and increase of middle-income population accompanied by change of life style is expected to occur there. Further, as a measure to cope with population increase anticipated to occur in these areas in future as well as world-wide food shortage problem, it is desirable that Indica rice may be provided in a conveniently edible form of cooked rice.

Accordingly, a primary object of the present invention is to provide a method of producing retort-sterilized cooked rice that can be distributed under a condition allowing consumption suitable for Indica rice as cooked rice and storage thereof at a room temperature and to provide also a retort-sterilized container-packed cooked rice.

### Solution

For accomplishing the above-noted object, according to a first characterizing feature of a method of producing retort-sterilized cooked rice relating to the present invention, the method comprises:

a heating water-absorption step for heating uncooked rice having a hardness ratio lower than 1 (one) for causing water to be absorbed therein such that resultant water-absorbed rice grains weigh from 2.0 to 2.6 times as much as the uncooked rice grains, the hardness ratio being calculated by dividing a Vickers hardness value of an intermediate point between an outermost point and a center point on a thickness line of rice grain by a Vickers hardness value of the center point;

a filling step for filling the heated, water-absorbed rice grains in a packing container;

a sealing step for sealing the filled packing container; and

a retort-sterilizing step for sterilizing the sealed packing container by heating and pressurizing.

With the above-described arrangement, uncooked rice of a long grain species having a hardness ratio lower than one is employed and this uncooked rice is heated and water-absorbed such that resultant water-absorbed rice grains weigh from 2.0 to 2.6 times as much as the uncooked rice grains. With this, the rice can be prepared under a state with cores of the grains thereof remaining therein. Then, under this state, the rice grains are filled in a packing container and then subject to a retort sterilization, whereby the rice grains can be heated sufficiently to the cores thereof, thus softening the cores. Namely, in the retort sterilization described above, steaming and sterilization of rice can be effected simultaneously.

Also with the above-described arrangement, by water absorption at the heating water-absorption step, an amount of water to be absorbed is adjusted in advance so as to allow cores to remain in the rice grains deliberately. Then, these rice grains will be processed to soften the cores therein by the heating and pressurization at the time of retort sterilization.

With the above-described arrangement, uncooked rice of a long grain species having a hardness ratio lower than one can be provided as retort-sterilized cooked rice (packed cooked rice) under a state having suitable mouthfeel and flavor for the local population in the production areas of such long grain species rice, for instance. Such packed cooked rice can be commercially distributed under a state allowing room-temperature storage thereof. Further, the rice can be provided in a ready-to-eat state in a convenient manner, requiring only heating of the container for instance.

According to a second characterizing feature of the method of producing retort-sterilized cooked rice relating to the present invention, the method further comprises a gas exchange step effected after the filling step for charging an amount of inert gas such that a concentration of oxygen gas in a headspace of the packing container may be 1% or more and less than 2%.

With the gas exchange step of charging of inert gas such that a concentration of oxygen gas in a headspace of the packing container may be higher than 1% and lower 2%, the cooked rice can be provided with good flavor. For instance, with this arrangement, a smell index can be controller to be 6 or lower.

According to a third characterizing feature of the method of producing retort-sterilized cooked rice relating to the present invention, the uncooked rice comprises Indica rice.

Indica rice is a long grain species of rice and accounts for 80% or more of the rice production amount in the world. The main production areas of Indica rice lie in Indochina peninsula and Southeast Asia such as Thailand. Therefore, with the above-described arrangement, it becomes possible to provide Indica rice in a conveniently edible form of cooked rice as a solution to cope with population increase foreseen to occur in future in these areas as well as world-wide food shortage problem.

According to a fourth characterizing feature of the method of producing retort-sterilized cooked rice relating to the present invention, the heating at the heating water-absorption step is effected at 70-100° C. for 6-7 minutes.

With the above-described arrangement, the heating water-absorption step can be effected at a temperature higher than the vicinity of the gelatinization peak temperature of the uncooked rice of the long grain species. Consequently, the heating and water absorption can be effected in an efficient manner.

According to a first characterizing feature of a retort-sterilized container-packed cooked rice relating to the present invention, the rice comprises rice grains provided by heating uncooked rice having a hardness ratio lower than 1 (one) for causing water to be absorbed therein such that resultant water-absorbed rice grains weigh from 2.0 to 2.6 times as much as the uncooked rice grains, the hardness ratio being calculated by dividing a Vickers hardness value of an intermediate point between an outermost point and a center point on a thickness line of rice grain by a Vickers hardness value of the center point and then retort sterilizing the water-absorbed rice grains.

With the above-described arrangement, an amount of water to be absorbed is adjusted in advance so as to allow cores to remain in the rice grains deliberately. Then, the rice grains can be processed to soften the cores therein by the heating and pressurization at the time of retort sterilization.

Consequently, uncooked rice of a long grain species having a hardness ratio lower than one can be provided as retort-sterilized cooked rice (container-packed rice) under a state having suitable mouthfeel and flavor for the local population in the production areas of such long grain species rice, for instance. Such container-packed cooked rice can be commercially distributed under a state allowing room-temperature storage thereof. Further, the rice can be provided in a ready-to-eat state in a convenient manner, requiring only heating of the container for instance.

According to a second characterizing feature of the retort-sterilized container-packed cooked rice relating to the present invention, an amount of inert gas is charged in a headspace of a packing container such that a concentration of oxygen gas may be 1% or more and less than 2%.

With such charging of inert gas in the headspace as provided in the above-described arrangement, flavor of cooked rice can be improved.

According to a third characterizing feature of the retort-sterilized container-packed cooked rice relating to the present invention, the uncooked rice comprises Indica rice.

With the above-described arrangement, the container-packed cooked rice can be provided as container-packed cooked rice taking advantage of unique mouthfeel, flavor or the like of the Indica rice. Therefore, with this container-packed cooked rice, Indica rice can be provided in a readily edible form conveniently, with only heating of the packing container. Moreover, the cooked rice can be provided in a state providing mouthfeel, flavor or the like preferred by the location population of the main production areas of Indica rice, in Indochina peninsula and Southeast Asia such as Thailand.

Furthermore, with the above-described arrangement, it becomes possible to provide Indica rice in a conveniently edible form of cooked rice as a solution to cope with population increase foreseen to occur in future in these areas as well as world-wide food shortage problem.

According to a fourth characterizing feature of the retort-sterilized container-packed rice relating to the present invention, each grain of the cooked rice has a hardness ranging from 56 to 115N and a water content ranging from 54 to 64%.

With the above-described arrangement, with restriction on the physical properties of the retort-sterilized container-packed cooked rice, the container-packed cooked rice can provide its mouthfeel and flavor for an extended period of time.

### BRIEF DESCRIPTION OF THE DRAWINGS

FIG. 1 is a flowchart showing a procedure of the inventive method of producing retort-sterilized cooked rice,

FIG. 2 is an explanatory view for calculation of a hardness ratio of a rice grain,

FIG. 3 is a graph showing hardness values of a single rice grain of container-packed cooked rice, immediately after retort sterilization, after three months and after six months thereof,

FIG. 4 is a graph showing water content values of container-packed cooked rice, immediately after retort sterilization, after three months and after six months thereof,

FIG. 5 is a graph showing smell indices of container-packed cooked rice, immediately after retort sterilization, after three months and after six months thereof,

FIG. 6 is a graph showing results obtained by implementing a scoring on container-packed rices (Example 2-1, Example 2-4, Example 2-7),

FIG. 7 is a graph showing results obtained by implementing the scoring on packed cooked rices (Example 2-4, Example 2-5, Example 2-6), and

FIG. 8 is a graph showing results obtained by implementing the scoring on Example 2-4 (six months after retort sterilization) and Control (normal cooked rice).

### EMBODIMENT

Next, an embodiment of the present invention will be explained.

According to a method of producing retort-sterilized cooked rice of the present invention, Indica rice, which is a long grain rice, is filled and sealed in a packing container and then subjected to a sterilization process by heating and pressurizing.

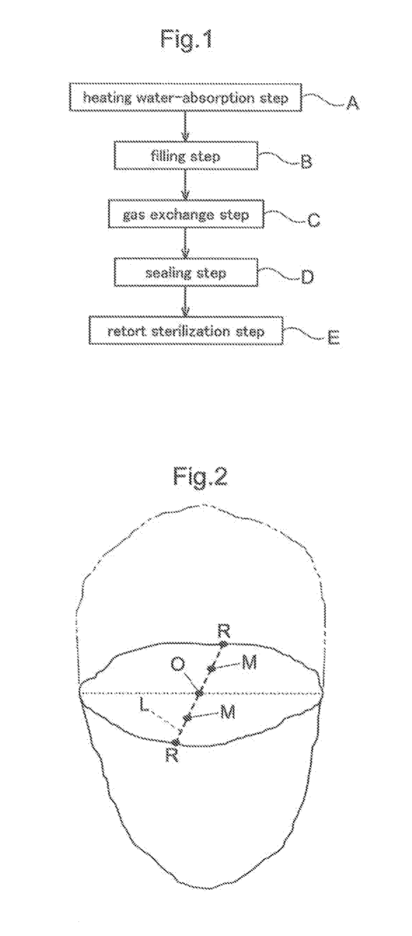

Namely, as shown in FIGS. 1 and 2, the inventive method of producing a retort-sterilized cooked rice includes: a heating water-absorption step A for heating uncooked rice having a hardness ratio lower than 1 (one) for causing water to be absorbed therein such that resultant water-absorbed rice grains weigh from 2.0 to 2.6 times as much as the uncooked rice grains, the hardness ratio being calculated by dividing a Vickers hardness value of a mid point M between an outermost point R and a center point O on a thickness line L of rice grain by a Vickers hardness value of the center point O; a filling step B for filling the heated, water-absorbed rice grains in a packing container; a gas exchange step C for charging an amount of inert gas such that a concentration of oxygen gas in a headspace of the packing container may be 1% or more and less than 2%; a sealing step D for sealing the filled packing container; and a retort-sterilization step E for sterilizing the sealed packing container by heating and pressurizing. In the above, the gas exchange step C can be effected according to a need.

### (Uncooked Rice)

Uncooked rice used in this invention is of a long grain species and can be e.g. Indica rice advantageously. However, it is not limited thereto, but can also be Carnaroli rice, which is also of a long grain species produced in Italy. Indica rice is characterized by its narrow elongate shape, including Thai rice. This Indica rice provides mouthfeel which is normally of low stickiness and dryness. On the other hand, Japonica rice which is produced mainly in Japan and has a roundish oval shape, exhibits stickiness and glossiness when heat is applied thereto. In this way, Indica rice differs from Japonica rice in appearance and mouthfeel. As the inventive method of producing a retort-sterilized cooked rice employs the Indica rice which is a long grain species, it will be advantageous if the rice takes advantage of unique mouthfeel, flavor or the like of the Indica rice. It is therefore believed that the retort sterilization should be effected under conditions different from those employed for the Japonica rice. In this embodiment, there will be explained a case using the Indica rice.

The Indica rice for use in the present invention has its hardness ratio defined by a value lower than 1 (one). This hardness ratio, as shown in FIG. 2, can be calculated by dividing a Vickers hardness value of a mid point M between an outermost point R and a center point O on a thickness line L of rice grain by a Vickers hardness value of the center point O. Two such mid points M exist in symmetry on the thickness line L about the center point O. Thus, as the Vickers hardness of the mid point M, an average of these two points can be employed.

The Vickers hardness (HV) is a kind of press-in hardness. For its determination, an indenter having a pyramid shape formed of a square shaped diamond is pressed into a material surface. The surface area will be calculated from lengths of diagonal lines of an indent that remains after removal of the load. A value obtained by dividing the calculated surface area by the test load is the Vickers hardness (HV).

By determining Vickers hardness of uncooked rice, the rice can be classified into I type (Indica type) or II type (Japonica type) (see article from Crop Science Society of Japan: Vol. 32, 181-189 (1963)). Specifically, rice having a hardness ratio lower than 1 is classified as the I type (Indica type), whereas rice having a hardness ratio higher than 1 is classified as the II type (Japonica type). More particularly, Ia type has a hardness ratio lower than 0.95 (significantly hard at its core), Ib type has a hardness ratio lower than 0.95-1.00 (slightly hard at its core), IIc type a hardness ratio lower than 1.00-1.10 (slightly soft at its core), IId type a hardness ratio lower than 1.10-1.18 (soft at its core and dorsoventral line portion), and IIe type a hardness ratio higher than 1.18 (extremely soft at its core and dorsoventral line portion). Such classification is closely related to the aspect of starch tissue and somewhat related to grain shape also. Incidentally, hard type rice of the Japonica is classified as IIc type. Soft type rice of the Japonica is classified as IId type and sake brewing rice of the Japonica is classified as IIe type.

### (Heating Water-Absorption Step)

At the heating water-absorption step A, adjustment is made such that resultant water-absorbed rice grain will weight 2.0-2.6, preferably 2.2-2.4, times as much as the uncooked rice grain. At the heating water-absorption step A, water absorption is carried out while heating uncooked rice by a boiling method (“Yutori” method) or steaming method. Namely, washed rice is soaked for a predetermined period in an amount of water heated to a predetermined temperature, and after lapse of the predetermined period, the soaking is stopped and water draining is effected.

For the rice washing, e.g. an amount of water twice as much as that of the uncooked rice is added to the rice and after a few tens of times of stirring, water will be drained. Or, this procedure can be repeated for several times if necessary. For instance, water-drained uncooked rice after washing will be put into water heated to 70-100° C. approximately. The lower limit (70° C.) of this temperature range is the temperature at which Indica rice starts its gelatinization. The upper limit (100° C.) is the temperature of boiled water at the normal pressure. As the gelatinization peak temperature of Indica rice is 75° C. approximately, when the uncooked rice is put into the water heated to 70-100° C. approximately, the heating water-absorption can proceed in an efficient manner. Incidentally, the gelatinization start temperature of the Japonica rice is around 60° C. The heating water-absorption can use not only boiled water, but stock, etc.

Preferably, the soaking period is about 5 to 8 minutes, more preferably, 6 to 7 minutes. For preparing Indica rice as cooked rice, normally, the rice will be steamed after boiling thereof for 10 to 15 minutes approximately for instance. At the heating water-absorption step A of this invention, the processing period is made shorter than standard boiling process, whereby the cores of the Indica rice grains can remain thereafter. Namely, at the heating water-absorption step A, in order to allow the cores of the Indica rice to remain therein, the soaking period is adjusted such that resultant water-absorbed rice grain will weight 2.0-2.6 times (heating water-absorption ratio) as much as the uncooked rice. In case a desired heating water-absorption ratio cannot be obtained by the adjustment of the soaking period alone, due to the amount of hot water and/or the amount of uncooked rice charged, additional adjustment can be made to achieve the desired heating water-absorption ratio by adding water or moisture at the time of weight measurement after water draining. The method of this water addition can be done by e.g. adding water to water-absorbed rice by spraying it or adding water to the container with using a nozzle or the like.

### (Filling Step)

At the filling step B, heated and water-absorbed rice grains are filled into a packing container. Water addition at the time of this filling can be omitted. In such case of sealing without any water addition, the water content of the rice grains will remain unchanged before/after retort sterilization. Therefore, it is possible to prevent development of stickiness of the cooked rice after the retort sterilization. If water addition is to be effected, a step of adding water by spraying water on the above-described water-absorbed rice or adding water to the container by a nozzle or the like can be carried at this filling step.

Advantageously the packing container is different from a “container” used for the heating water-absorption step A. The packing container is not particularly limited, but can be any container that allows accommodation of rice and its retort sterilization therein. For instance, the packing container will be of a type that has heat resistance for withstanding heating sterilization at a high temperature and that also allows commercial distribution of the product at a room temperature. The container can be a can-like container, a bag-like container, a container-like retort pouch, a retort cup, a retort tray, having a barrier function for shielding against oxygen gas, light or some absorptivity for oxygen gas, sealability and practical strength, etc. Here, the retort pouch is made of films laminated on the food keeping side thereof with polypropylene and on the outer side thereof with synthetic resin such as polyester (PET) or aluminum foil, etc. The capacity of the packing container is not particularly limited, but a capacity of 100-600 mL approximately will be advantageous for readiness of handling at the time of retort sterilization and a capacity of 550 mL or less will be advantageous when the period required for retort sterilization is taken into consideration.

### (Gas Exchange Step)

At the gas exchange step C, an amount of inert gas will be introduced such that the concentration of oxygen gas present in a headspace of the packed container may range higher than 1% and lower than 2%.

The components and composition of gas present in the headspace can sometimes affect the color and/or flavor of the cooked rice. For instance, in case no oxygen at all exits in the headspace (the case of charging nitrogen as inert gas by 100%), reduction will occur at a part of protein, which renders bluish tone to the rice grains. To the contrary, in case oxygen exists at a high concentration in the headspace, the flavor of the cooked rice becomes poor. For this reason, at the gas exchange step C in this invention, the gas component of the headspace is adjusted such that the concentration of oxygen gas present in a headspace of the packed container may range higher than 1% and lower than 2%. The gas to be introduced other than oxygen gas may not be insert gas such as nitrogen gas, but can be carbon dioxide gas instead. As for the concentrations of such gases, any concentrations can be appropriately set as long as the concentration of the oxygen gas is 1% or more and less than 2%. For instance, in the case of setting the concentration of oxygen gas to 1-1.2%, charging and adjustment can be done such that the concentration of the carbon dioxide gas ranges from 50 to 70% to provide 100% total concentration when combined with the nitrogen.

For charging such gases in the headspace, this charging can be effected by introducing each gas individually into the headspace via a syringe or the like from a gas feeding device. Or, after all gases are mixed by a gas mixer or the like, the resultant mixture gas can be charged and introduced in the headspace by using such syringe or the like.

Incidentally, the capacity of the headspace can be set according to the size of the packing container. For instance, in the case of a packing container having a capacity of 400 mL, a headspace of 150 mL approximately can be secured.

### (Sealing Step)

At the sealing step D, the packing container is sealed. This sealing can be done by any appropriate known method according to the packing container to be used. For instance, if the packing container is a container-like retort pouch, sealing thereof can be done by heat-welding the main body of the packing container and a lid member with using a known sealer or the like. At the time of this sealing, meat, vegetable, prepared in an appropriate size, powder seasoning, dried food, etc. can be added to the rice grains at the same time.

### (Retort Sterilization Step)

At the retort sterilization step E, sterilization process is effected by heating and pressurizing the sealed packing container.

Here, the “retort sterilization” means a pressurizing heating treatment, in which the product filled in a heat-resistant container is pressurized in such as a manner to avoid breakage of the container due to the internal pressure of the product associated with rise of the temperature, and the product is heated for about 10-50 minutes with steam or hot water of 110° C.-130° C., thus ensuring commercial sterilization. Such retort sterilization can employ a butch type retort sterilization device or a continuous type retort sterilization device.

As regards to the specific method of heating, since heating until the inside temperature of the subject food product up to 110-130° C. at the normal pressure is practically difficult, the heating will be effected under a pressurized condition. For instance, a hot-water type pressurizing heating sterilization machine or a pressurizing type pressure cooker may be used, advantageously.

As described above, at the heating water-absorption step A, with use of the processing period shorter than normal rice cooking, the cores remain in the Indica rice grains. However, with heating and pressurizing at the retort sterilization step E, the Indica rice will be heated to its core, thus softening the cores. In this way at the retort sterilization step E, steaming and sterilization of the rice can be effected at one time.

After completion of the retort sterilization step E, there can be obtained retort-sterilized container-packed cooked rice in which each rice grain has a hardness ranging from 56 to 115N and a water content ranging from 54 to 64%. Further, with this container-packed cooked rice, its smell index can be set to be 6 or lower. Therefore, the retort-sterilized container-packed cooked rice of the present invention can be provided as rice food taking advantage of the unique mouthfeel, flavor, or the like of the Indica rice. Therefore, with the container-packed cooked rice described above, only with heating, it becomes possible to provide Indica rice in a conveniently edible form of cooked rice and also the Indica rice can be provided in a form providing mouthfeel and flavor preferred by the populations of the main production areas of Indica rice in Southeast Asia such as Thailand or Indochina peninsula, i.e. in a form suitable for their consumption.

After completion of the retort sterilization step E, by cooling with progressive temperature drop, the product can be stored at an appropriate temperature and humidity.

### EXAMPLES

### Example 1

The retort-sterilized container-packed cooked rice of the present invention assumes its consumption in the main production areas of Indica rice in Southeast Asia such as Thailand or Indochina peninsula. Thus, investigation was made regarding hardness, water content and flavor preferred at the time of consumption of Indica rice.

As Indica rice, Thai rice (Thai fragrant rice: from Doverfield Far East Ltd.) was employed. This Thai rice was prepared into normal cooked rice and retort-sterilized cooked rice, respectively. The packing container used for the retort-sterilized cooked rice was a rice-cooking laminated plastic cup: LA 180X118-370WT (PP/adhesive layer/EVOH/adhesive layer/PP). The original sheet thickness of the cup was 0.67 mm and EVOH was contained by 4 w/w %. The lid member was 12XBJ15NBJ50RQ (from the outer side, 12 μm vapor deposited PET/15 μm deposited nylon/50 μm polypropylene).

The normal rice cooking was carried out in an electric rice cooker (NP-BT10, from ZOJIRUSHI Corporation). 300 g of uncooked Thai rice was filled into the electric cooker and 600 mL of ion exchange water was introduced and 4 times of rice washing were effected, each time with 30 times of hand mixing and draining of rice washing water. Ion exchange water having a weight obtained by multiplying the weight of uncooked rice by predetermined ratios (1.1, 1.2, 1.3, 1.4, 1.5, 1.6, 1.7, 1.8, 1.9 relative to 1 weight of uncooked rice) was introduced. Without providing any water-absorption period, the rice was cooked by “polished rice, normal mode” provided by the electric rice cooker. The weights of the respectively cooked rice samples were divided by the weight (300 g) of the uncooked rice, thus providing respective heating water-absorption ratios.

The retort-sterilized cooked rice was made in the following manner.

After uncooked Thai rice was washed in the manner described above, the rice was put into a sieve to drain water and then put into boiling water of 100° C. Then, with occasional stirring, boiling was effected for heating and water absorption. The boiling was effected for a period from 5 to 9 minutes. After the rice was put into the sieve in a manner not to crush its rice grains, water was drained. The weights of the respective rice samples after boiling were divided by the weight of the uncooked rice employed to provide heat water-absorption ratios.

180 g of the heated water-absorbed rice was filled in the laminated plastic container, and then after gas exchange by 25 seconds flushing at a flow rate 8 L/min. of a reference gas made of three kinds of gas (oxygen 1-1.2%, carbon dioxide 50%, balanced by nitrogen gas, from Sumitomo Seika Chemicals), the lid member was sealed at a welding temperature of 200° C. for a welding period of 2 seconds by a semi-automatic sealer (SN-2S, from Shinwa Kikai Co., Ltd.).

With using a retort simulator (H130-C110, from Toyo Seikan Ltd.), retort sterilization was effected under the following conditions. Heating was effected with a primary heating for 5 minutes, at a preheating temperature of 70° C. for a preheating period of 5 minutes, a secondary heating for 10 minutes at a secondary temperature of 100° C., a tertiary heating for 10 minutes and 118° C. of temperature during the sterilization process and the process was effected to obtain a final F₀ value of 8. Cooling was effected with a primary temperature dropping for 10 minutes, an initial cooling temperature 90° C. and secondary temperature dropping for 10 minutes, dropping temperature of 40° C. And, the process was terminated when the temperature of the center portion inside the container (product temperature) reached 40° C. Water chiller temperature was set to 15° C. After discharge from the retort cooker, water adhering to the container was removed by an air gun.

Sensory evaluations were conducted on the normal cooked rice and the retort-sterilized cooked rice.

Seven Thai persons were employed as panelists. And, the aptitude of the panelists was checked by five-taste test. In addition to such five-taste test, another test was conducted in which two kinds of water were added to the five tastes and the panelists were asked to identify the 5 tastes out of the 7 (seven). A panelist making two or fewer errors was determined as being qualified.

Of the normal cooked rices, nine kinds thereof containing 1.1-1.9 water relative to 1 weight of rice were used for sensory evaluations. Further, as for the retort-sterilized cooked rice, five kinds thereof with boiling of 5-9 minutes were used for the sensory evaluations. In order to maintain the temperature at the time of evaluations constant, each cooked rice by 10 g was put into a white small dish and subjected to a microwave heating to reach a temperature of about 55° C., then was presented before the panelists.

As to the hardness of each sample for evaluation, each panelist was asked to give evaluation O for a sample for which he/she finds preferable, evaluation of A for a sample for which he/she finds acceptable and evaluation of X for a sample for which he/she finds unacceptable.

For grasping the physical properties of cooked rice, a high compression test was conducted in which compression was made to reduce the height of each grain to 90% thereof.

A compact table tester (EZ-2, from Shimatzu Corporation) mounting a single grain on a 10 or 200 N load cell was placed on a testing table and a compression operation for pressing a disc-shaped jig having 30 cm diameter was pressed against it at a compression rate of 2.0 mm/sec. to 90% of the height of the sample was carried out two times in repetition. And, after 10 times of trial, an average value was obtained. And, the force required for the first compression was used as “hardness (H)”.

Further, based on the official method (method of weight reduction for a chosen amount at 105° C. for 5 hours of drying), water contents were determined at 105° C.

<Results and Study>

(1) Physical Properties and Sensory Evaluations of Normal Cooked Rice

Physical properties, measured water contents and heating water absorption ratios of the normal cooked rice comprised of Thai rice cooked by the electric rice cooker are shown in Table 1 below. The hardness decreased with increase of water. The results of sensory evaluations relating to hardness are shown at the right end in Table 1.

TABLE 1
Physical properties and sensory evaluations of electric cooker cooked
rice by way of differences in weight ratio between rice and water

| | electric rice cooker | | | |
|---|---|---|---|---|
| | | | heating | |
| | hardness of | | water- | |
| rice:water | single rice | water | absorption | sensory |
| weight ratio | grain (N) | content (%) | ratio (times) | evaluation |
| 1:1.1 | 120.3 | 50.5 | 1.9 | X |
| 1:1.2 | 114.6 | 54.4 | 2.0 | Δ |
| 1:1.3 | 99.3 | 55.9 | 2.1 | Δ |
| 1:1.4 | 91.5 | 58.0 | 2.2 | ◯ |
| 1:1.5 | 83.9 | 59.9 | 2.35 | ◯ |
| 1:1.6 | 69.9 | 61.2 | 2.4 | ◯ |
| 1:1.7 | 61.3 | 62.9 | 2.5 | Δ |
| 1:1.8 | 56.3 | 64.1 | 2.6 | Δ |
| 1:1.9 | 55.1 | 64.4 | 2.7 | X |

panelists: Thai persons
rice: Thai rice
◯: preferable
Δ: acceptable
X: unacceptable

For the five-taste testing in the sensory evaluation of normal cooked rice, all of the seven panelists were found being qualified.

As the results, the sample having the rice-water weight ratio of water 1.1 for rice 1 was evaluated too hard to be acceptable. The sample with rice:water=1:1.9 was evaluated too soft to be acceptable. The acceptable samples were: rice:water=1:1.2-1.8. As a result of interviews with the panelists, the most preferred cooked rice had rice:water=1:1.5.

Referring this sensory evaluation result in correspondence with the hardness values of one rice grain shown in Table 1, it is seen that the preferred cooked rice sample (rice:water=1:1.5) has a hardness value of 83.9 N. The acceptable rice samples had a value of 56.3 N for the sample of rice:water=1:1.8 to a value of 114.6 N for the sample of rice:water=1:1.2. Therefore, based on the hardness determination values and the sensory evaluation results, it was found that the preferred “hardness” of Thai rice ranges from 56 to 115 N approximately, when the water content ranges from 54.4 to 64.1(54-64)% and the heating water-absorption ratio ranges from 2.0 to 2.6.

(2) Physical Properties and Sensory Evaluations of Retort-Sterilized Cooked Rice

Physical properties, water contents and heating water-absorption ratios of retort sterilize rice with varied boiling period are shown in Table 2 below.

TABLE 2
Physical properties and sensory evaluations of retort-sterilized cooked
rice due to difference of boiling period

| | heating water- | retort cooked rice | | |
|---|---|---|---|---|
| boiling | absorption ratio | hardness of | | |
| period | after water draining | single rice | water | sensory |
| (minutes) | adjustment (times) | grain (N) | content (%) | evaluation |
| 5 | 2.1 | 103.3 | 59.3 | Δ |
| 6 | 2.2 | 84.5 | 61.2 | ◯ |
| 7 | 2.35 | 74.4 | 62.1 | ◯ |
| 8 | 2.6 | 63.8 | 64.8 | Δ |
| 9 | 2.7 | 54.3 | 65.8 | X |

panelists: Thai persons
rice: Thai rice
◯: preferable
Δ: acceptable
X: unacceptable

Regarding the hardness of single rice grain, in comparison of the influence of boiling period, it was found that the longer the boiling period (heating water-absorption step A), the lower the hardness. As described hereinbefore, the Thai rice which the panelists found acceptable had hardness values ranging from 56 to 115N, which correspond approximately in range to the boiling periods of 5 to 8 minutes (63.8 to 103.3N). And, the water contents of these were from 59.3 to 64.8%. The sample preferred in the sensory evaluation had boiling period ranging from 6 to 7 minutes.

### Example 2

Study was made to find a preferred gas composition of the headspace for the retort-sterilized container-packed cooked rice.

The Thai rice used in Example 1 was washed by the method of Example 1. At the heating water-absorption step A, boiling was effected for 7 minutes and the rice was put into a sieve in a manner not to crush the grains thereof and then water was drained. At the time of weight determination, adjustment was made by uniformly spraying hot water such that resultant water-absorbed rice grain had weight as much as 2.35 times as that of the uncooked rice. 180 g of the heated water-absorbed rice was filled in a laminated plastic cup (filling step B).

Gas exchange of the headspace was effected with using mixture gas of nitrogen gas:oxygen gas, or of nitrogen gas:oxygen gas:carbon dioxide gas such that the oxygen gas present in the headspace had 1% concentration (gas exchange step C). At the time of sealing, for the purpose of gas exchange, the mixture gas was flushed at a flow rate of 0.2 MPa·8 L/min. for a period of 25 seconds through a gap formed between the cup and the lid member; then, sealing was effected at a welding temperature of 200° C. for a welding period of 2.0 seconds with using the afore-mentioned semi-automatic sealer (sealing step D). Further, in order to study the effect of permeate oxygen during storage period, a sample was also made which comprised of the packing container being housed in a gas impermeable aluminum pouch (an “outer shell”). Packing of the outer shell was effected either before retort sterilization or after retort sterilization. A list of such samples are shown in Table 3 below.

TABLE 3

| | exchange gas (composition: | |
|---|---|---|
| | nitrogen gas:oxygen gas:carbon | presence/absence of outer |
| | dioxide gas) | shell |
| Control | air charging (no exchange gas) | none |
| Example 2-1 | 99:1:0 | none |
| Example 2-2 | 99:1:0 | packing after retort |
| | | sterilization |
| Example 2-3 | 99:1:0 | packing before retort |
| | | sterilization |
| Example 2-4 | 49:1:50 | none |
| Example 2-5 | 49:1:50 | packing after retort |
| | | sterilization |
| Example 2-6 | 49:1:50 | packing before retort |
| | | sterilization |
| Example 2-7 | 29:1:70 | none |
| Example 2-8 | 29:1:70 | packing after retort |
| | | sterilization |
| Example 2-9 | 29:1:70 | packing before retort |
| | | sterilization |

Incidentally, the “outer shell” refers to an arrangement of the laminated plastic cup being packed and sealed in an aluminum pouch together with oxygen scavenger. The samples packed before retort sterilization were subject to retort sterilization after it was confirmed that O₂ present within the aluminum pouch had been consumed by the oxygen scavenger. With such packing and O₂ removal prior to retort sterilization, it is possible to block entrance of oxygen which may enter the cup from the outside during the retort packing. As for the samples packed after retort sterilization, entering oxygen can be blocked during storage.

At the retort sterilization step E, the afore-mentioned retort simulator was employed and the step was conducted under the following conditions. Unless indicated otherwise, the indicated temperatures represent temperatures of the cooker. Heating was effected by temperature raising to 70° C. in 5 minutes, temperature holding at 70° C. for 5 minutes, temperature raising to 100° C. in 10 minutes, temperature raising to 118° C. in 10 minutes, so that the temperature during the sterilization process was set to 118° C. and the process was effected to obtain a final F₀ value of 8. Cooling was effected by gradual temperature dropping to 90° C. in 10 minutes and when the temperature (product temperature) at the inner center portion of the container became 40° C., the cooling was terminated. Water chiller temperature was set to 15° C. After removal from the retort cooker, water adhering to the container was removed by an air gun. Thereafter, all samples were stored in a constant temperature and humidity chamber at 30° C. and 80% RH.

Samples of retort sterilized cooked rice produced as above were evaluated.

The compact table tester used in Example 1 was used again for determination of physical property (hardness) of the retort sterilized cooked rice. Further, by the same method as employed in Example 1, water contents were measured.

For determination of aroma of the retort sterilized cooked rice, 50 g of cooked rice was put into an HS gas collection bottle. After heating for 30 minutes in 55° C. water bath, under this water bathed condition continued, the collection bottle was connected to a line of an automatic concentrating device (7100A, from ENTEC Corporation) and 200 mL of HS gas introduced into the device. The introduced gas was concentrated in MPT mode and then subjected to GC-MS analysis. As analysis conditions, DB-WAX column (length: 60 m, inside diameter: 0.25 mm, membrane thickness: 0.25 μm) was attached to GC and helium was fed at a linear velocity of 39 cm/sec. The oven temperature (kept at 40° C. for 4 minutes) and temperature was raised to 140° C., with increment of 5° C. in each minute, temperature was raised then to 220° C., with increment of 15° C. in each minute, and then maintained at 220° C. for 5 minutes); inlet temperature: 220° C., transfer line temperature: 230° C., ionization chamber temperature: 230° C., ionization method: EI, ionization voltage: 70 eV, scanning range: m/z 28.7-350.0, 1.8 scans per second.

For quantitative calculation, after 100 mL of reference gas having a known concentration (HAPs-J9, from Sumitomo Seika Chemicals) was introduced into the device, analysis was effected similarly to obtain a peak area of 1,2-Dichloroethane. With using this at 50 ppb, by a correction efficient 1, concentrations of two components (Acetaldehyde, Dimethyl sulfide) characterizing aroma of cooked rice and two components (Pentanal, Hexanal) characterizing old rice smell were calculated. A value obtained by the following formula was used as a “smell index” (the greater its value, the stronger the old rice smell).

smell index=(combined concentration of Pentanal and Hexanal)÷Acetaldehyde concentration

Sensory evaluation was made by the scoring. In this scoring, 10 points is set as the perfect score, 3.3 points is the acceptable limit value, values of 6.6 or higher are preferred values. Five Thai people were employed as panelists. From each sample, 10 g of cooked rice was put into a white dish. For keeping the temperature at the time of evaluation constant, after heating to about 55° C. by microwave, the samples were presented to the panelists.

### <Results And Study>

(1) Physical Property (Hardness) of Retort Sterilized Container-Packed Cooked Rice

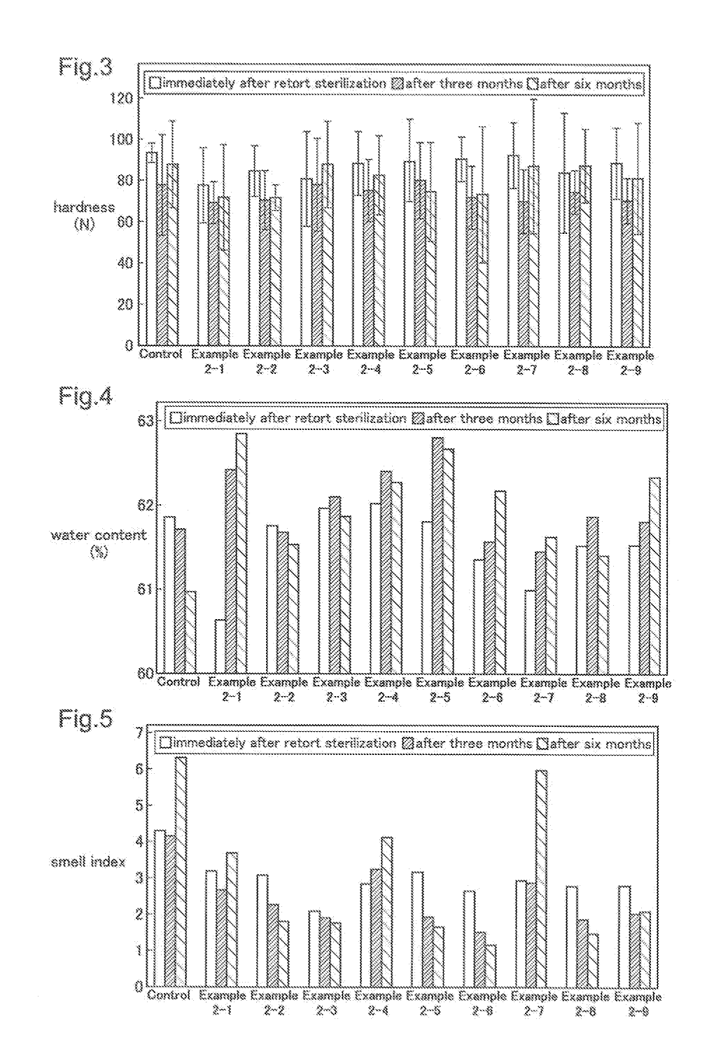

Changes over time of hardness of single rice grain are shown in FIG. 3. As a result, Examples 2-1 through 2-9 satisfied the range 56-115N of the “hardness” evaluated as being acceptable in the sensory evaluation in all cases of immediately after, three months after and six months after, the retort sterilization of container-packed cooked rice.

(2) Water Content of Retort Sterilized Container-Packed Cooked Rice

The results of water content determination are shown in FIG. 4. As a result, Examples 2-1 through 2-9 provided values ranging from 60 to 63% approximately in all cases of immediately after, three months after and six months after, the retort sterilization of container-packed cooked rice.

(3) Aroma Component of Retort Sterilized Container-Packed Cooked Rice

The results of aroma index calculation are shown in FIG. 5. As a result, in the case of Control, the sample of six months after the retort sterilization exhibited a smell index exceeding 6, thus found as having an unacceptable smell. On the other hand, Examples 2-1 through 2-9 exhibited smell indices lower than 6 in all cases of immediately after, three months after and six months after, the retort sterilization of container-packed cooked rice.

(4) Sensory Evaluation of Retort Sterilized Container-Packed Cooked Rice

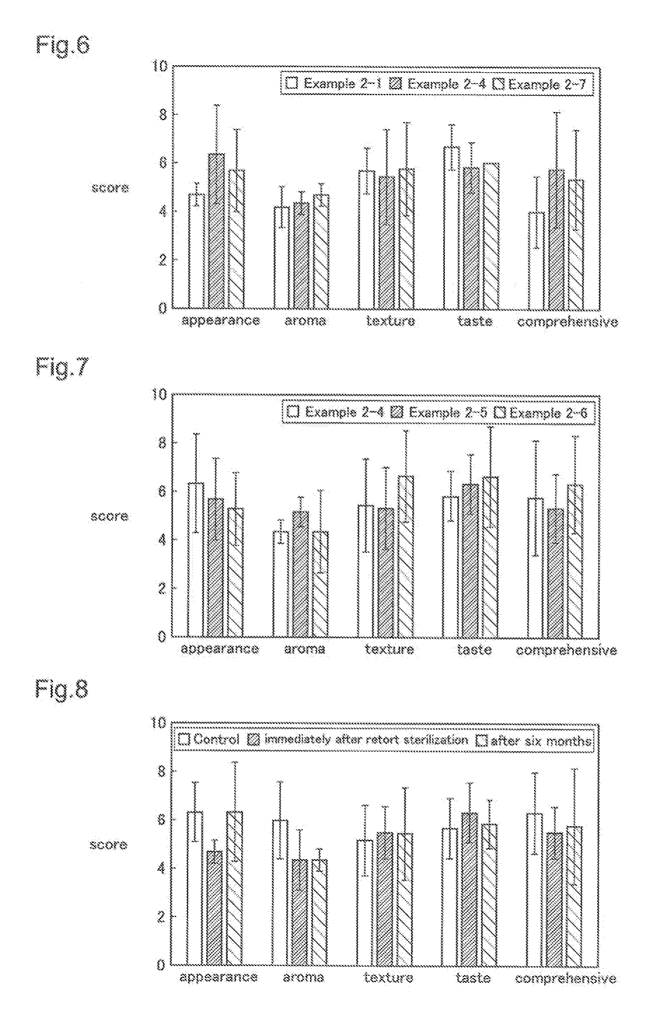

On container-packed cooked rice samples having different residual oxygen amounts after 6 months storage at 30° C., 80% RH, evaluations were made by the scoring with Thai people. Evaluation items were: appearance, flavor, texture, taste, comprehensive evaluation. As the samples, sample Example 2-1, Example 2-4 and Example 2-7, which all had no outer shell, were used. The results are shown in FIG. 6.

As a result, Example 2-1, Example 2-4 and Example 2-7 all were evaluated as being acceptable in their appearances, but slight differences being present in their scores among them. Being susceptible to the appearance, the comprehensive evaluation showed the same tendency as the appearances. In the other items, i.e. aroma, texture and taste, differences among the three were minor. From this, it was found that oxygen entering the inside of container after retort sterilization hardly gives influence on the sensory properties of cooked rice.

Example 2-4 without outer shell, Example 2-5 provided with an outer shell after the retort sealing and Example 2-6 provided with an outer shell before the retort sealing were stored for sixth months at 30° C., 80% RH and then evaluated by the scoring with the Thai people. Evaluation items were: appearance, flavor, texture, taste, comprehensive evaluation. The results are shown in FIG. 7.

The results in all of the evaluation items were found acceptable. From the result obtained with Example 2-4 having no outer shell, it was found that with use of a cup and a lid member having gas barrier function, the container-packed cooked rice will provide results acceptable by Thai people in the respective items for an extended period of time in spite of absence of outer shell.

Example 2-4 (immediately after retort sterilization and 6 months storage at 30° C., 80% RH) and normal cooked rice (rice:water=1:1.5) prepared by cooking in an electric rice cooker of the Thai rice of Example 1 as Control were evaluated by the scoring with the Thai people. Evaluation items were: appearance, flavor, texture, taste, comprehensive evaluation. The results are shown in FIG. 8.

The results in all of the evaluation items were found acceptable. In particular, respecting texture and taste, Example 2-4 provided superior evaluation than Control. Thus, it was found that Example 2-4 provides container-packed cooked rice acceptable for Thai people, not inferior to the normal cooked rices which is Control.

Incidentally, in the examples described above, the oxygen gas concentration of the headspace was set to 1%. However, it is believed that similar result can be achieved with introduction of inert gas so that the oxygen gas concentration in the headspace ranges 1% or more and less than 2%.

### Example 31

Carnaroli rice, which is of a long grain species produced in Italy, was employed as raw material and washed in the same manner as the above examples using Indica rice (Thai rice) and then put into boiling water to be boiled for 12 minutes (heating water-absorption). With water draining after the boiling, water was added such that the water-absorbed rice grain weighed 2.35 times as much as the uncooked rice. Then, 180 g of this adjusted rice was charged into a packing container (laminated plastic cup). And, like the above examples using Thai rice, the lid member was sealed with simultaneous gas exchange for obtaining an oxygen gas concentration 1% or more and less than 2% and then retort sterilization (sterilization temperature: 118° C., sterilization period: 25 minutes) was effected and cooled. After removal from the retort cooker, water adhering to the container was removed by the air gun.

The cooked rice after 1 week storage at the room temperature provided physical properties of hardness 103.9N, water content 64.0%. Both these values were within the ranges of the physical properties of the inventive container-packed cooked rice (hardness of single rice grain: 56-115N, water content: 54-64%).

### Comparison Example 1

Polished rice of “Hitomebore”, which is hard rice of a short grain species produced in Japan (IIc type (hardness ratio: lower than 1.00-1.10)) was used as raw material and washed in the same manner as the above examples using Indica rice (Thai rice) and then put into boiling water to be boiled for 13 minutes (heating water-absorption). With water draining after the boiling, water was added such that the water-absorbed rice grain weighed 2.35 times as much as the uncooked rice. Then, 180 g of this adjusted rice was filled into a packing container (laminated plastic cup). And, like the above examples using Thai rice, the lid member was heat-sealed with simultaneous gas exchange for obtaining an oxygen gas concentration 1% or more and less than 2% and then retort sterilization (sterilization temperature: 118° C., sterilization period: 25 minutes) was effected and cooled. After removal from the retort cooker, water adhering to the container was removed by the air gun.

The cooked rice after 1 week storage at the room temperature showed single rice grain hardness of 54.1 N, indicating the grain being too soft. Namely, it was found that with “Hitomebore”, which is hard rice of a short grain species produced in Japan (IIc type), boiling (heating water-absorption) to a heating water absorption ratio of 2.0-2.6 results in almost total softening of rice grain core, so softness becomes excessive with the subsequently effected retort sterilization.

Further, with again using the hard rice (IIc type) “Hitomebore”, container-packed cooked rice was made with deliberating keeping the rice grain cores by reduction of the boiling period to 7 minutes (all the other conditions remained the same).

The cooked rice after 1 day storage at the room temperature showed single rice grain hardness of 84.1 N (average hardness of 10 grains), but the lower layer portion inside the container had absorbed too much water, thus giving stickiness, and there were significant water absorption irregularities of rice grains belonging in the upper layer portion and the lower layer portion in the packing container. This was found to be attributable to the following. Namely the reduction of the boiling period to seven minutes resulted in reduction in the amount of water absorbed in the rice, and an amount of water found deficient at the time of cup filling for achieving the heating water absorption ratio of 2.0-2.6 was added, but this led to absorption of the water by the rice grains in the lower layer portion inside the container, so that the excessive softness developed therein after the retort sterilization, whereas the rice in the upper layer portion became rather hard.

Therefore, with boiling in correspondence with the heating water-absorption ratio ranging from 2.0 to 2.6 for achieving favorable mouthfeel of the rice grains after completion, this is inappropriate for eating for the hard rice (IIc type) “Hitomebore” since it will result in excessive softness after retort sterilization. Also, the retort sterilization thereof with deliberately keeping the grain cores with the reduction of the boiling period to 7 minutes proved also inconvenient and inappropriate for easing as it led to excessive irregularity of water content in the rice grains inside the packing container.

### INDUSTRIAL APPLICABILITY

The present invention is applicable to a method of producing retort-sterilized container-cooked rice comprising filling and sealing long-grain rice in a packing container and then sterilizing it by heating and pressurizing, and applicable also to retort sterilized container-packed cooked rice.

### DESCRIPTION OF REFERENCE MARKS

A: heating water-absorption step
B: filling step
C: gas exchange step
D: sealing step
E: retort sterilization step

1. A method of producing retort-sterilized cooked rice, the method comprising:
heating uncooked rice having a hardness ratio lower than 1 (one) for causing water to be absorbed therein such that resultant water-absorbed rice grains weigh from 2.0 to 2.6 times as much as the uncooked rice grains, the hardness ratio being calculated by dividing a Vickers hardness value of an intermediate point between an outermost point and a center point on a thickness line of rice grain by a Vickers hardness value of the center point;
filling the heated, water-absorbed rice grains in a packing container;
sealing the filled packing container; and
sterilizing the sealed packing container by heating and pressurizing.

2. The method of producing retort-sterilized cooked rice according to claim 1, further comprising a gas exchange, effected after the filling of the heated, water-absorbed rice grains, for charging an amount of inert gas such that a concentration of oxygen gas in a headspace of the packing container may be 1% or more and less than 2%.

3. The method of producing retort-sterilized cooked rice according to claim 1, wherein the uncooked rice comprises Indica rice.

4. The method of producing retort-sterilized cooked rice according to claim 1, wherein the heating for causing water to be absorbed is effected at 70-100° C. for 6-7 minutes.

5. A retort-sterilized container-packed cooked rice comprising rice grains provided by heating uncooked rice having a hardness ratio lower than 1 (one) for causing water to be absorbed therein such that resultant water-absorbed rice grains weigh from 2.0 to 2.6 times as much as the uncooked rice grains, the hardness ratio being calculated by dividing a Vickers hardness value of an intermediate point between an outermost point and a center point on a thickness line of rice grain by a Vickers hardness value of the center point and then retort sterilizing the water-absorbed rice grains.

6. The retort-sterilized container-packed cooked rice according to claim 5, wherein an amount of inert gas is charged in a headspace of a packing container such that a concentration of oxygen gas may be 1% or more and less than 2%.

7. The retort-sterilized container-packed cooked rice according to claim 5, wherein the uncooked rice comprises Indica rice.

8. The retort-sterilized container-packed cooked rice according to claim 5, wherein each grain of the cooked rice has a hardness ranging from 56 to 115N and a water content ranging from 54 to 64%.
